(19) United States
(12) Patent Application Publication
(10) Pub. No.: US 2011/0099423 A1
(43) Pub. Date: Apr. 28, 2011

(54) Unified Boot Code with Signature

(76) Inventors: Chih-Ang Chen, Saratoga, CA (US); Maziar H. Moallem, Cupertino, CA (US); Joong-Seok Moon, Cupertino, CA (US)

(21) Appl. No.: 12/606,615

(22) Filed: Oct. 27, 2009

(51) Int. Cl. G06F 11/22; G06F 9/00

(52) U.S. Cl. 714/25; 713/2; 714/E11.145

(57) ABSTRACT

In an embodiment, code, such as the boot code for an integrated circuit or set of integrated circuit products, is provided in a system. The code may be a unified code base including multiple code blocks. Additionally, a signature is provided which describes the integrated circuit on which the boot is being performed. The signature may be processed (e.g. by a processor included in the integrated circuit) to determine which of the code blocks to execute. Accordingly, a single image of the boot code may be used for a variety of different integrated circuits and/or different integrated circuit implementations. For example, the same unified boot code may be used with one or more simulation models, or various programmable logic device models, that include various subsets of the components of the integrated circuit. The code blocks may correspond to various components, and may include tests for the corresponding components.

### BACKGROUND

1. Field of the Invention

This invention is related to the field of electronic systems and, more particularly, to booting and/or testing electronic systems.

2. Description of the Related Art

As the number of transistors included in integrated circuits increase, as well as the functional complexity of the integrated circuits, the mechanisms for testing the integrated circuit become more complex as well. For example, integrated circuits often include processors, e.g. system-on-a-chip (SOC) circuits that include processors and other components, or chip-mulitprocessors (CMP) that include two or more processors and interfacing circuitry. Such integrated circuits may have associated boot code that initializes the integrated circuit for operation and/or tests the integrated circuit for correct operation.

The higher complexity of some integrated circuits can prevent the building of test models of the entire integrated circuit (e.g. simulation models or models in programmable logic devices such as field programmable gate arrays). Accordingly, multiple test models can be supported for testing various parts of the integrated circuit. The test models can include subsets of the overall integrated circuit, and support testing of the subset. For each test model, a version of the boot code is created that can initialize the model and/or test the model. The numerous versions of the boot code create confusion among the individuals responsible for testing. When the wrong version of the boot code is used, a failure can be reported simply because a component is not in the model, for example. Or, a wrong version of the boot code may not include a test for a component that is included, and subsequent failures that occur may be due to a failure in the untested component. Valuable test time can be lost while the individuals involved attempt to discern reasons for failure.

### SUMMARY

In an embodiment, code, such as the boot code for an integrated circuit or set of integrated circuit products, is provided for a system. The code may be a unified code base including multiple code blocks. Additionally, a signature is provided which describes the integrated circuit on which the boot is being performed. The signature may be processed (e.g. by a processor included in the integrated circuit) to determine which of the code blocks to execute. Accordingly, a single image of the boot code may be used for a variety of different integrated circuits and/or different integrated circuit implementations. For example, the same unified boot code may be used with one or more simulation models, or various programmable logic device models, that include various subsets of the components of the integrated circuit. The same unified boot code may also be used for different integrated circuit produces in a product line.

Accordingly, issues related to identifying the correct boot code for a given implementation of the integrated circuit may be eased, in some embodiments. The signature may be created along with the implementation, and may be automatically created as part of the model creation process, in some embodiments. In some embodiments, the signature may further support the insertion of custom code into the boot code and/or override of the default boot code with signature-specific overrides.

### BRIEF DESCRIPTION OF THE DRAWINGS

The following detailed description makes reference to the accompanying drawings, which are now briefly described.

FIG. 1 is a block diagram of one embodiment of an integrated circuit.

FIG. 2 is a block diagram illustrating a portion of a design and test process for an integrated circuit.

FIG. 3 is a block diagram of one embodiment of a boot read-only memory (ROM).

FIG. 4 is a block diagram illustrating one embodiment of a signature.

FIG. 5 is a flowchart illustrating one embodiment of boot code.

FIG. 6 is a flowchart illustrating one embodiment of creating a signature and providing boot code with the signature.

FIG. 7 is a block diagram of one embodiment of a computer accessible storage medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

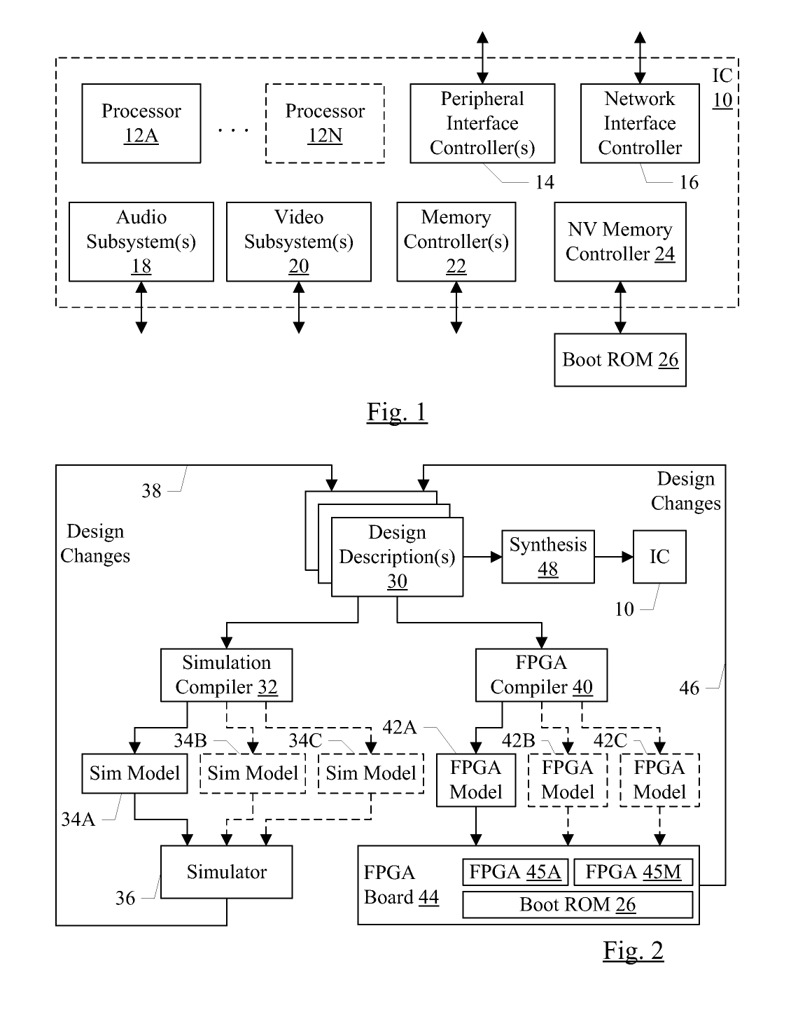

Turning now to FIG. 1, a block diagram of one exemplary embodiment of an integrated circuit (IC) 10 is shown. In the illustrated embodiment, the integrated circuit 10 may include at least one processor 12A, and may optionally include additional processors such as processor 12N. In the illustrated embodiment, the integrated circuit 10 may be an SOC including various peripheral circuitry such as one or more peripheral interface controller(s) 14, one or more network interface controllers 16, one or more audio subsystems 18, one or more video subsystems 20, one or more memory controllers 22, and/or one or more non-volatile (NV) memory controllers such as NV memory controller 24. The NV memory controller 24 may be coupled to a boot read-only memory (ROM) 26 that is not included in the IC 10, in the illustrated embodiment. It is noted that other embodiments may include any subset of the components shown in FIG. 1, or any superset of the components shown and other components, or any subset of the components and other components, as desired. Specifically, in one embodiment, the boot ROM 26 may be included in the IC 10 with the other components.

The components 12A-12N, 14, 16, 18, 20, 22, and 24 may be coupled in any desired fashion, not shown in FIG. 1. For example, one or more buses, point-to-point links, etc. may be used to couple the components. Generally, a component may refer to any block of circuitry having a defined functionality, interface to other components, and software interface (as appropriate).

The processors 12A-12N may be configured to execute the instructions defined in the instruction set architecture implemented by the processors. Any instruction set architecture may be used in various embodiments. In some embodiments, one or more of the processors 12A-12N may implement different instruction set architectures, or different versions of the same instruction set architecture. The processors 12A-12N may include circuitry and, in some cases, may include microcode. Generally, a processor may be integrated with other components in an integrated circuit (e.g. as shown in FIG. 1), may be a discrete microprocessor, and/or may be included with one or more other components in a multi-chip module implementation, in various embodiments.

The peripheral interface controllers 14 may be configured to serve as a bridge between the components and one or more peripheral interfaces to which devices may be coupled. Peripheral interfaces may include, for example, peripheral component interconnect (PCI), PCI Express (PCIe), Institute for Electrical and Electronic Engineers (IEEE) 1394 or “Firewire”, universal serial bus (USB), HyperTransport, etc. The network interface controllers 16 may be configured to communicate between the components and devices coupled to one or more network interfaces. The network interfaces may include Ethernet, asynchronous transfer mode (ATM), token ring, etc. The audio subsystem 18 may be configured to process audio data, and may communicate with audio input/output devices such as a microphone, speakers, headphones, etc. The video subsystem 20 may be configured to process video data, and may communicate with video input/output devices such as display screens, cameras, etc. The memory controllers 22 may be configured to communicate with external memory, such as various forms of volatile memory (e.g. static random access memory (SRAM), dynamic random access memory (DRAM), synchronous DRAM (SDRAM), double data rate (DDR, DDR2, DDR3, etc.) SDRAM, low-power DDR (LPDDR2) SDRAM, RAMBUS DRAM, etc. The memory controllers 22 may be coupled to one or more DRAM chips, or may be coupled to one or more memory modules comprising circuit boards to which one or more DRAM chips are mounted.

The NV memory controller 24 may be configured to communicate with one or more non-volatile memory devices such at the boot ROM 26. Generally, a non-volatile memory device may be any memory device that is designed to retain data stored in the memory device when the power to the memory device is removed. For example, a ROM may be a non-volatile memory device. Other non-volatile memory devices may include Flash memory, programmable ROMs of various types, battery-backed SRAM, etc. While a ROM will be used as an example in the remainder of this discussion for storing the boot code, any non-volatile memory may be used.

The boot ROM 26 may store boot code for the IC 10. When the IC 10 is powered on, the boot code may be executed to test the various components of the IC 10 and/or to initialize the components for use. That is, one or more of the processors 12A-12N may execute the boot code stored in the boot ROM 26. When included in an electronic system shipped as a product, the boot code may be part of the basic initialization of the system, after which the control software for normal operation (e.g. the operating system, in some electronic systems) may be loaded and executed. During design and testing of the IC 10, the boot code may test and initialize the components to provide a predicable, stable starting environment for various other tests to be run. The boot code may be used in a single processor environment (e.g. only one processor 12A-12N is included), and may also be used in multi-processor (MP) environment. The MP environment may be symmetric, in which the processors 12A-12N execute effectively as equals, or may be asymmetric. The MP environment may include a master execution processor 12A and one or more special purpose processors such as I/O processors 12N or one or more slave processors 12N. Any MP environment may be supported in various embodiments.

In one embodiment, the boot code may be unified code. That is, the same code may be executed across various integrated circuit products, across various models of the integrated circuit or portions thereof, and/or across various target platforms. In an embodiment, the boot code may be arranged as a set of code portions, or code “blocks.” Each code block may be associated with a component. Accordingly, if a given model includes a component, the corresponding code block may be executed. If the given model excludes the component, the corresponding code block may not be executed. Thus, only those code blocks included in a given model may be executed. Furthermore, code blocks for each included component may be assured of executed. If a test failure occurs, the failure may occur because there is a problem with the component or its integration with the other components in the model. If the tests all pass, the components included in the model are known to be tested and functional to the level checked by the boot code. Thus, the code blocks in this embodiment may be designed to test the corresponding components, ensuring that the components are functional in the model. The code blocks may also be designed to initialize components and/or discover components in various embodiments, in addition to testing the components or as an alternative to testing the components.

In an embodiment, a signature is included in the boot ROM 26 in addition to the boot code. The signature may comprise data that describes the model/implementation of the integrated circuit 10, and thus may be an indication of which components are included or excluded. The boot code may read the signature, and may process the signature to determine which code blocks are to be executed. The boot code may selectively execute the code blocks, dependent on the signature. The signature may also include various additional data, described in more detail below.

It is noted that, while FIG. 1 illustrates components integrated onto a single semiconductor substrate as the integrated circuit 10, other embodiments may implement discrete components and/or combinations of discrete components and integrated components in a system. Any amount of discrete components or integration may be used. The integrated circuit 10 will be used as an example below, but any system of components may be used in other embodiments. As mentioned previously, the boot ROM 26 may be included in the integrated circuit 10, in some embodiments.

Turning next to FIG. 2, a block diagram of a portion of a design and test process for the integrated circuit 10 is shown. The integrated circuit design may be represented as one or more design descriptions 30. The design descriptions 30 may be stored in a set of files for convenient editing and change tracking. For example, each component may be represented by one or more design description files 30. The design descriptions may be coded using a high-level design language (HDL) such as Verilog, Very HDL (VHDL), etc. In one embodiment, the design descriptions may be register-transfer level (RTL) descriptions expressed in an HDL. In one embodiment, the design descriptions 30, when taken as a whole, describe the integrated circuit 10.

The design descriptions 30 may be processed in a variety of ways. For example, the design descriptions may be compiled to a variety of target platforms for testing. Generally, a target platform may comprise any combination of compiled design descriptions and other supporting hardware and/or software executed on hardware to test the design represented by the design descriptions. In the embodiment illustrated in FIG. 2, both a simulation platform and a programmable logic device (PLD) platform are supported. More specifically, in the illustrated embodiment, the PLD environment may be a field programmable gate array (FPGA) environment. Generally, a PLD may be any electronic component that is reconfigurable to implement different hardware operation. Exemplary PLDs may include FPGAs, programmable array logic (PAL), complex PLDs, Flash devices, various programmable ROMs, etc. The FPGA environment will be used as an example herein, but any PLD may be used in other embodiments.

When compiling to a target platform, a model of the integrated circuit based on the design description files 30 may created. The model may be an electronic representation of the integrated circuit 10 (or a subset of the components from the integrated circuit 10) that may be operated in the target environment to implement the operation of the integrated circuit 10 or the components. For some embodiments of the integrated circuit 10, the entire integrated circuit may not be represented in a single model. For example, a simulation model that represents the entire integrated circuit 10 may be too large to simulate in the available computer systems, or may be inefficient for performing targeted testing of one or more components (where much of the rest of the model would be idle, but would still affect the speed of the simulation). An FPGA model of the entire integrated circuit may be larger that may physically fit into the FPGA devices provided on a development board to which the FPGA model may be downloaded. Accordingly, various “builds” of the integrated circuit 10 may be supported to test components of the integrated circuit 10, combinations of the components, etc.

Accordingly, the design descriptions 30 may be compiled by a simulation compiler 32 into one or more simulation models 34A-34C. The simulation models 34A-34C may represent different sets of components of the integrated circuit 10, different integrated circuit products (e.g. different SOC products in a line of SOC products to be sold by the entity that is designing the SOC, etc.). Different products may include different combinations of components, different component implementations, etc. The simulation models 34A-34C may be read by a simulator 36, which may simulate the model using various input test vectors (not shown). The simulator 36 may be software program that executes on a computer system or systems, and thus a simulation may be a fully software operation. On the other hand, an FPGA model may be downloaded into reconfigurable hardware that implements the components in the reconfigurable hardware.

Executing the simulation model in the simulator 36 may lead to the discovery of incorrect operation, or “bugs” in the design. The designer may review the simulation results and implement design changes (arrow 38), updating the design descriptions 30 for subsequent testing. Executing the simulation model in the simulator 36 may include executing the boot code from the boot ROM 26 on a processor that is included as part of the simulation model 34A-34C.

Similarly, an FPGA compiler 40 may compile the design descriptions into one or more FPGA models 42A-42C. The FPGA models 42A-42C may comprise “bit streams” of data that may be downloaded into the FPGAs on the FPGA board 44, to configure the FPGA board 44 to implement the operation described in the design files. The FPGA board 44 may include one or more FPGAs 45A-45M along with configurable interconnect between the FPGAs. The FPGA board 44 may also include a boot ROM 26 storing the boot code and the signature. Alternatively, the contents of the boot ROM 26 contents may be downloaded to an FPGA 45A-45M to serve as the boot ROM 26. The FPGA model 42A-42C executed on the FPGA board 44 may include executing the boot code from the boot ROM 26 on a processor represented in the FPGAs 45A-45M.

Executing various tests on the FPGA model 42A-42C may result in the detection of various bugs, which may cause the designer to make design changes (arrow 46).

The design descriptions 30 may also be synthesized using a synthesis tool 48 (and other design tools, such as timing analysis tools, place and route tools, etc.). to produce a description of the IC 10 that can be transmitted to a semiconductor fabrication facility to produce the IC 10.

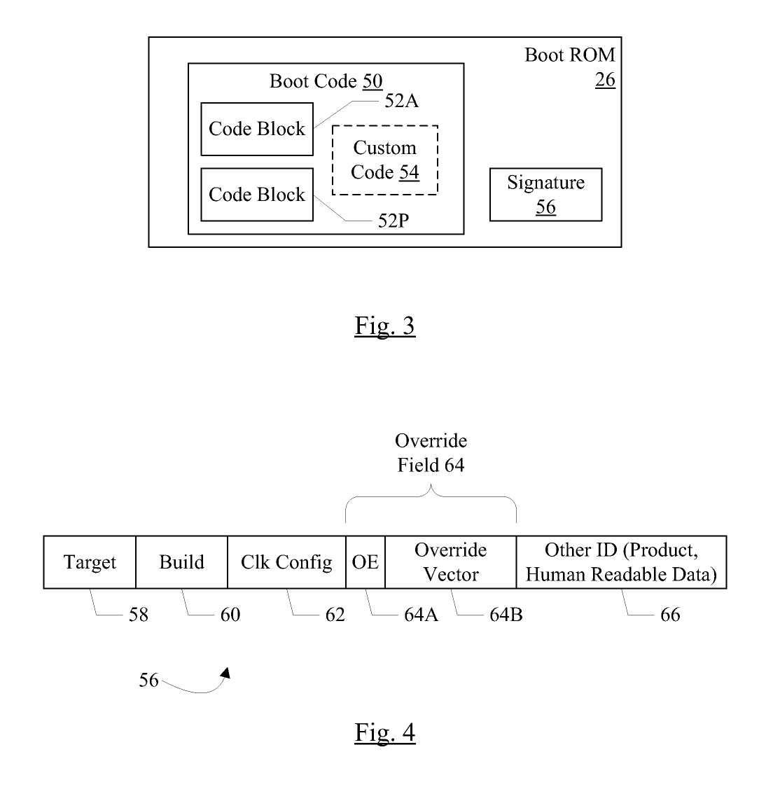

Turning now to FIG. 3, a block diagram of one embodiment of the boot ROM 26 is shown. In the illustrated embodiment, the boot ROM 26 may store the boot code 50, which may comprise multiple code blocks 52A-52P. The code blocks 52A-52P may form the unified code described previously. The code blocks 52A-52P may, when executed, test the corresponding components, as mentioned above. The code blocks 52A-52P may initialize the components and/or discover the components as well, as previously mentioned. In some cases, the boot ROM 26 may store custom code 54 in addition to the unified code. The custom code 54 may be inserted by a user (e.g. a designer that designed at least a portion of the integrated circuit 10 represented in the design descriptions 30, a test engineer responsible for verification of the integrated circuit 10, etc.). The custom code 54 may be associated with a particular model/implementation of the integrated circuit 10, to perform a specific operation desired in that model/implementation.

The custom code 54 may be located at a specific address in the boot ROM 50, to which the boot code 50 may branch to execute the custom code 54. Alternatively, the boot code 50 may be compiled from source code in a higher level language (e.g. C, C++, etc.), and the custom code 54 may be included as an additional module to be compiled into the boot code 50.

The boot ROM 26 also stores the signature 56, which may be generated during the creation of the corresponding model and/or during the compilation of the boot code 50. The compiler 32 or 40 may generate the signature, or other code executed during the creation of the corresponding model may generate the signature.

FIG. 4 is a block diagram illustrating one embodiment of the signature 56. The signature 56 may include a variety of fields storing data describing the corresponding model/implementation. In the illustrated embodiment, for example, the signature 56 may include a target field 58, a build field 60, a clock configuration field 62, an override field 64, and an other ID field 66. Other embodiments may include any subset of the field shown and/or other fields.

The target field 58 may include data that describes the target platform for the corresponding model/implementation. For example, the target field may specify simulation, FPGA, etc.

The build field 60 may include data that describes the which build of the product is represented in the corresponding model/implementation. The build may indicate which components are included and excluded, for example. The data in the build field 60 may indirectly specify components that are included or excluded (e.g. the boot code 50 may map the data in the build field 60 to a known set of builds, each including/excluding specific components). Alternatively, the build field 60 may directly specify the included and/or excluded components (e.g. by listing the components, as a bit vector with a bit for each component that is set to indicate included or clear to indicate excluded or vice versa, etc.).

The clock configuration field 62 may specify the clock operation for the integrated circuit 10. For example, the clock configuration field 62 may specify one or more clock frequencies to be used in the FPGA implementation (such as minimum and maximum frequencies, or frequencies for two or more clocks used in the system). The clock configuration field 62 may also be used in the simulation model to specify clocks.

The override field 64 may include data to override the default set of code blocks that would be selected responsive to the build field 60. In the illustrated embodiment, for example, the override field 64 may include on override enable (OE) 64A and an override vector 64B. The override enable 64A may indicate whether or not the override is specified. For example, the override enable 64A may be a bit indicating override when set, and no override when clear (or vice versa). The override vector 64B may include a bit vector with a bit per code block (including the custom code 54, if applicable). The bit may be set to indicate that the corresponding code block is to be executed and may be clear to indicate no execution (or vice versa).

The other ID field 66 may store other information. For example, in embodiments in which the boot code 50 supports multiple integrated circuit products, the other ID field 66 may include data describing the product. Other data, including human readable data that may be displayed for a user on a display screen, for example, may be in the other ID field 66. For example, the human readable data may include version information for the boot code, an identifier for the user who created the boot ROM image, a timestamp, etc. In an exemplary embodiment, the human readable data may include a project name, a boot code revision indication, a design release indication, contact information in case a user needs assistance, and a date. The design release indication, in one embodiment, may refer to the location of a bit stream that programs the FPGAs.

The data in various fields of the signature 56 may be coded in any fashion. For example, a given field may be binary-coded to specify different values in the field. Alternatively, a given field may comprise a text string (e.g. coded as American Standard Code for Information Interchange (ASCII) characters or any other character codes) that may describe the information. A given field may comprise a numerical value. Combinations of one or more of binary-coded data, numerical values, and/or text strings may be used in embodiments. Different fields may have different types of data. Accordingly, a signature describing a corresponding model/implementation may generally include any combination of data directly or indirectly indicating or identifying the model/implementation, the components included and/or excluded in the model/implementation, etc.

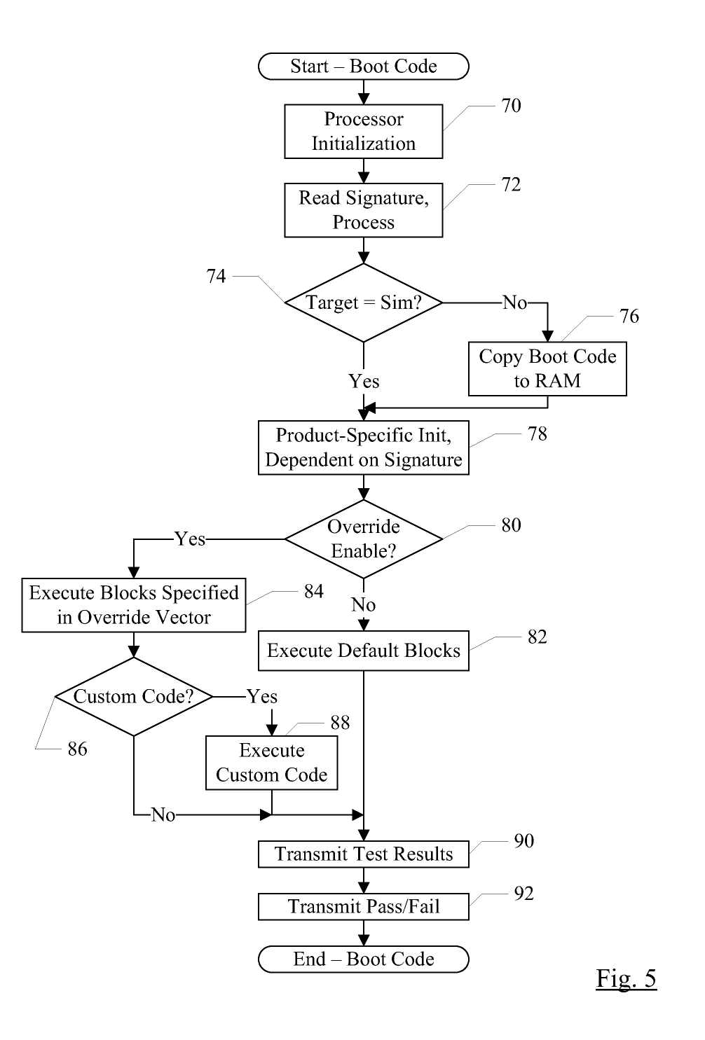

Turning now to FIG. 5, a flowchart is shown illustrating one embodiment of the boot code 50. The boot code 50 may include instructions which, when executed by a processor in the integrated circuit 10, implement the operation shown in FIG. 5. The integrated circuit 10 may be as modeled for simulation and/or an FPGA implementation, for example. While the blocks are shown in a particular order for ease of understanding, other orders may be used.

The boot code 50 may begin with processor initialization (block 70). The initialization may include writing various control and configuration registers to set the processor in the desired execution mode for operation. The boot code 50 may read the signature 56 and process the signature 56 (block 72). The signature 56 may be stored at a predetermined (“known”) address in the boot ROM 26, and the boot code 50 may include a load to the known address. In some embodiments, the boot code 50 may write one or more text strings and/or graphical data to a display screen visible to a user, either read directly from the signature 56 or determined responsive to the data in the signature 56 (or a combination of directly read data and determined data).

If the target field of the signature 56 indicates simulation (decision block 74, “yes” leg), the simulator 36 may have loaded the boot code into an internal memory of the integrated circuit 10 or an external memory to which the integrated circuit 10 is coupled in the simulation model. Executing the boot code from the internal or external memory (e.g. a RAM) may be higher performance than executing from the boot ROM 26, in some embodiments. Accordingly, if the target field of the signature 56 indicates simulation, the boot code 50 may skip copying of the boot code into RAM (since the simulator 36 has already placed the boot code 50 in the RAM). If the target field of the signature does not indicate simulation (e.g. it indicates FPGA), then the boot code 50 may copy the boot code image into the RAM (block 76). For example, the boot code 50 may read the boot ROM 26 and write the RAM using load and store instructions. Alternatively, the boot code 50 may be executed out of the boot ROM 26 and the blocks 74 and 76 may be eliminated.

The boot code 50 may perform various product-specific initializations, dependent on the signature (block 78). The product-specific initializations may include initializations of various components that are included in the product (e.g. writing various control and configuration registers in the components). The product-specific initializations depend on the signature because, if a given component is not included in the current model/implementation, then the corresponding initializations may be skipped.

The boot code 50 may determine if the override enable 64A indicates override (decision block 80). If not (decision block 80, “no” leg), the boot code 50 may proceed to execute the default code blocks for the given signature (block 82). That is, the boot code 50 may selectively execute various code blocks 52A-52P dependent on the signature, executing those code blocks 52A-52P that correspond to components of the integrated circuit 10 that are included in the implementation/model described by the signature 56 and not executing code blocks 52A-52P that correspond to components of the integrated circuit 10 that are not included in the implementation/model described by the signature 56. As mentioned previously, the default code blocks 52A-52P may test the corresponding components, and/or initialize and/or discover the corresponding components.

On the other hand, if the override enable indicates override (decision block 80, “yes” leg), the boot code 50 may execute the code blocks 52A-52P specified in the override vector 64B (block 84). That is, the boot code 50 may process the override vector 64B and execute each code block specified by a corresponding set bit in the override vector. The specified code blocks may include the custom code 54 as well, in this embodiment (decision block 86, “yes” leg and block 88). In other embodiments, the custom code 54 may be specified via a different field in the signature 56 and thus may be independent of the override enable. In the present embodiment, for example, the default code blocks for the signature and the custom code 54 may be executed by setting the override enable and specifying the default code blocks and the custom code in the override vector. In an embodiment that separately specifies the custom code 54, the override enable may not be used if the only desired change to the default code blocks is to include the custom code 54.

At least some of the executed code blocks may be test code designed to verify operation of the components. The test code may determine test results (e.g. pass/fail and/or error data) which may be transmitted (block 90), and an overall pass/fail for the boot code 50 may also be transmitted (block 92). The transmissions may be performed, e.g. over an external interface such as a peripheral interface or network interface. In one embodiment, a universal asynchronous receiver-transmitter (UART) interface may be used. Other embodiments may use any other peripheral interface or network interface, e.g. the exemplary interfaces discussed previously. Alternatively or in addition to the above transmissions, some embodiments may couple one or more light emitting diodes (LEDs) or other visual indicators to one or more outputs of the FPGAs (e.g. FPGA pins being used as general purpose I/O (GPIO) pins of the IC 10). Test results may be communicated by activating the LEDs (e.g. by toggling the levels on the GPIO pins). Additionally, the LEDs may be used to indicate the progress of a series of tests being performed by the test code.

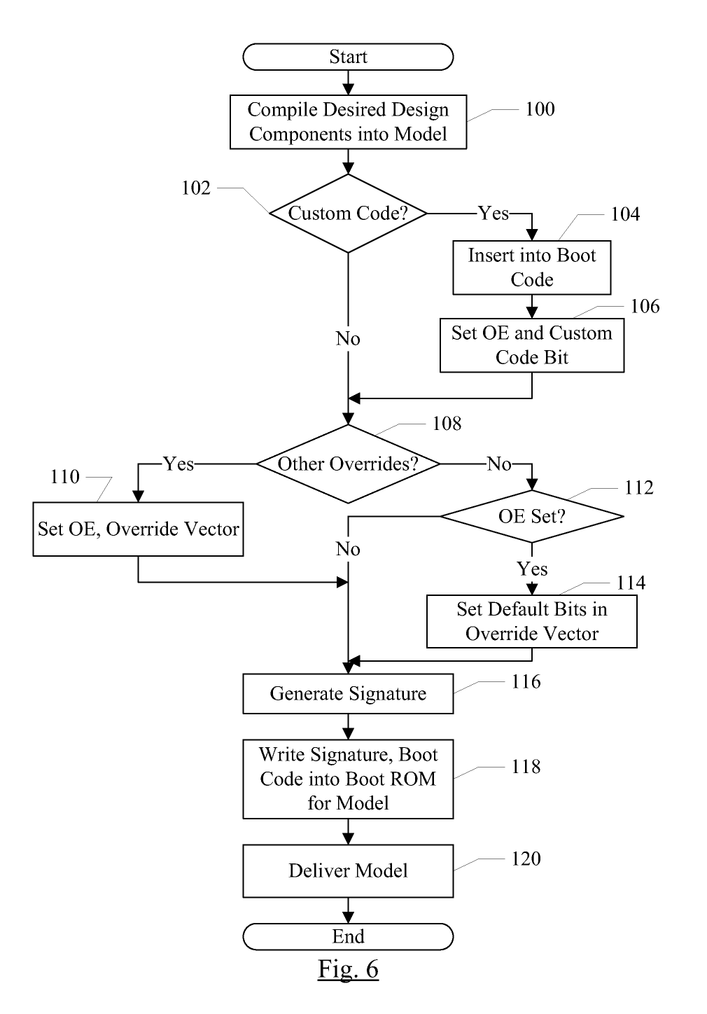

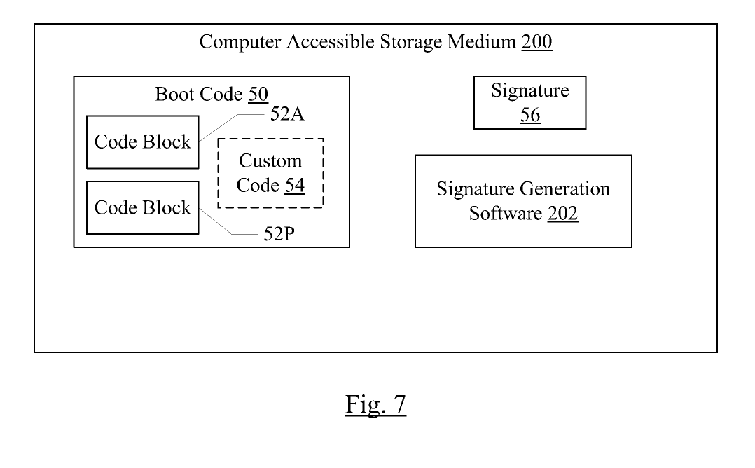

Turning now to FIG. 6, a flowchart is shown illustrating one embodiment of creating a signature and providing boot code with the signature. While the blocks are shown in a particular order for ease of understanding, other orders may be used. The method may be performed in part by the compilers 32 or 40 as specified below. The remainder of the operation of FIG. 6 may be performed by signature generation software executed on a computer during model creation. For example, the signature generation software and/or the compilers 32 or 40 may include instructions which, when executed on a computer, implement the operation shown in FIG. 6.

The compiler 32 or 40 (depending on the desired platform) may compile the design descriptions 30 of the desired components into a model (block 100). If the user has included custom code 54 (decision block 102, “yes” leg), the signature generation software may insert the custom code 54 into the boot code 50 (block 104). In one embodiment, the boot code 50 may be compiled from source files and inserting the custom code 54 may be part of the compilation operation for the boot code 50. In another embodiment, the boot code 50 may have a reserved location in the boot ROM 26 for the custom code 54, and the signature generation software may insert the custom code 54 into the boot code 50 at the reserved location. The signature generation software may set the override enable 64A in the signature, and may set the custom code bit in the override bit vector 64B (block 106).

The signature generation software may determine if the user has specified any other overrides besides the possible custom code 54 (decision block 108). Other overrides may be specified even if the custom code 54 is not specified. The other overrides may be specified in any desired fashion (e.g. via a configuration file or other user input). If there are other overrides (decision block 108, “yes” leg), the signature generation software may set the override enable 64A and may generate the override vector 64B based on the specified overrides (block 110). If there are no other overrides (decision block 108, “no” leg), but the override enable is set (because the custom code is provided—decision block 112, “yes” leg), the signature generation software may set the bits in the override vector corresponding to the default code blocks to be executed for the model (block 114).

The signature generation software may generate the signature 56, with the target field 58 specifying the target platform, the build field 60 identifying the model, the clock configuration field 62, the override field 64 as determined above, and the other ID field 66 (block 116). The signature generation software may write the boot code 50 and the signature 56 into the boot ROM 26 (block 118), and may deliver the model to the target platform (block 120). It is noted that, while some signature data may be provided from sources such as the design files, user input, etc., another source of signature data may be the boot code 50 itself. For example, the boot code revision indication may be extracted from the boot code 50.

Turning next to FIG. 7, a block diagram of a computer accessible storage medium 200 is shown. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW or Blu-Ray. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory such as Flash memory accessible via a peripheral interface such as the Universal Serial Bus (USB) interface, etc. Storage media may include microelectromechanical systems (MEMS), as well as storage media accessible via a communication medium such as a network and/or a wireless link. The computer accessible storage medium 200 in FIG. 7 may store the boot code 50 (including the code blocks 52A-52P and optionally the custom code 54), which may implement the flowchart of FIG. 5. The computer accessible storage medium 200 may also store the signature 56, and may store the signature generation software 202 which may implement portions of the flowchart of FIG. 6. Generally, the computer accessible storage medium 200 may store any set of instructions which, when executed, implement a portion or all of the flowcharts shown in FIGS. 5-6. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A system comprising:
a programmable logic device implementation of at least a portion of a first integrated circuit product; and
a computer accessible storage medium coupled to the programmable logic device implementation, the computer accessible storage medium storing:
unified code that comprises code portions, each code portion executable on at least one of two or more integrated circuit products, wherein the first integrated circuit product is one of the two or more integrated circuit products; and
a signature that describes the first integrated circuit product, wherein the unified code, when executed in the programmable logic device implementation by a processor represented in the programmable logic device implementation, processes the signature and selectively executes code portions of the unified code that pertain to the first integrated circuit product.

2. The system as recited in claim 1 wherein at least a subset of the code portions are each associated with a different component of the first integrated circuit product, and wherein code portions within the subset that are selected for execution responsive to the signature correspond to components that are included in the programmable logic device implementation, and wherein the code portions in the subset that are not selected for execution responsive to the signature correspond to components that are excluded from the programmable logic device implementation.

3. The system as recited in claim 1 wherein the signature comprises an override vector comprising indications corresponding to each of the code portions, wherein the override vector indications indicate which code portions are to be executed.

4. The system as recited in claim 3 wherein the override vector comprises an indication corresponding to custom code that is includable in the computer accessible storage medium for execution, and wherein the custom code is provided by a user of the programmable logic device implementation to accomplish a specific task not included in the unified code.

5. A computer accessible storage medium storing:
test code that comprises a plurality of test code blocks; and
a signature that indicates a first model of an integrated circuit, the first model implemented on a first target platform, wherein the test code, when executed on the first target platform, processes the signature and selectively executes the plurality of test code blocks responsive to the signature, wherein the plurality of test code blocks test the integrated circuit for correct operation.

6. The computer accessible storage medium as recited in claim 5 wherein the first target platform comprises a simulation platform, and wherein a first test code block of the plurality of test code blocks that copies the test code from the computer accessible storage medium into memory within the integrated circuit is not executed on the simulation platform.

7. The computer accessible storage medium as recited in claim 6 wherein the first test code block is executed on a programmable logic device platform.

8. The computer accessible storage medium as recited in claim 5 wherein the first target platform comprises a programmable logic device platform.

9. The computer accessible storage medium as recited in claim 8 wherein the programmable logic device platform is a field programmable gate array platform.

10. The computer accessible storage medium as recited in claim 5 wherein the signature further includes data indicative of which components of the integrated circuit are included in the first model, and wherein a subset of the plurality of test code blocks each correspond to a different component of the integrated circuit, and wherein the selective execution comprises executing one or more test code blocks in the subset that correspond to one or more components that are included in the first model and not executing those one or more other test code blocks that correspond to one or more components that are not included in the first model.

11. A computer accessible storage medium storing:
code that comprises a plurality of code blocks, each code block corresponding to a different component of a system; and
a signature that describes a first implementation of the system, wherein the first implementation includes a subset of the components of the system, wherein the code, when executed by a processor in the first implementation: processes the signature, executes a first subset of the plurality of code blocks that correspond to components included in the first implementation responsive to the signature, and does not execute a second subset of the plurality of code blocks that correspond to components not included in the first implementation, wherein each code block tests the corresponding component of the integrated circuit.

12. The computer accessible storage medium as recited in claim 11 wherein the signature further includes an override field, wherein the override field is codable to override the first subset and select the plurality of code blocks to be executed.

13. The computer accessible storage medium as recited in claim 12 wherein the override field includes an indication of whether or not a custom code block is included, wherein the processor is configured to execute a the custom bode block if the indication indicates that the custom code block is included.

14. A method comprising:
compiling a plurality of components corresponding to an integrated circuit into a model;
generating a signature for unified code, wherein the unified code includes a plurality of code blocks, and wherein the unified code is executable on any model of the integrated circuit, and wherein the signature indicates which of the plurality of components are included in the model and is processed by a processor included in the model to determine which of the plurality of code blocks is to be executed; and
writing the signature into a non-volatile memory that also stores the unified code.

15. The method as recited in claim 14 further comprising inserting a custom code block into the plurality of code.

16. The method as recited in claim 15 wherein the generating comprises coding an override field of the signature to indicate presence of the custom code block.

17. The method as recited in claim 14 wherein the generating further comprises coding an override field to override a default set of the plurality of code blocks to be executed, wherein the default set is dependent on the signature.

18. The method as recited in claim 17 wherein the override field comprises an override enable and an override vector, wherein the override vector comprises a bit for each of the plurality of code blocks, indicating whether or not the corresponding code block is to be executed.

19. The method as recited in claim 18 wherein the override enable indicates whether or not an override is desired.

20. The method as recited in claim 18 wherein the override vector comprises a bit corresponding to a custom code block.
